(19) United States
(12) Patent Application Publication
(10) Pub. No.: US 2024/0303908 A1
(43) Pub. Date: Sep. 12, 2024

(54) MULTIRESOLUTION DEEP IMPLICIT FUNCTIONS FOR THREE-DIMENSIONAL SHAPE REPRESENTATION

(71) Applicant: GOOGLE LLC, Mountain View, CA (US)

(72) Inventors: Yinda Zhang, Daly City, CA (US); Danhang Tang, West Hollywood, CA (US); Ruofei Du, San Francisco, CA (US); Zhang Chen, Beijing (CN); Kyle Genova, San Mateo, CA (US); Sofien Bouaziz, Los Gatos, CA (US); Thomas Allen Funkhouser, Menlo Park, CA (US); Sean Ryan Francesco Fanello, San Francisco, CA (US); Christian Haene, Berkeley, CA (US)

(21) Appl. No.: 18/547,628

(22) PCT Filed: Apr. 30, 2021
(86) PCT No.: PCT/CN2021/091706

§ 371 Date: Aug. 23, 2023

(51) Int. Cl. G06T 15/08; G06T 3/40; G06T 9/00; G06T 19/20

(52) U.S. Cl. CPC G06T 15/08; G06T 3/40; G06T 9/00; G06T 19/20

(57) ABSTRACT

A method including generating a first vector based on a first grid and a three-dimensional (3D) position associated with a first implicit representation (IR) of a 3D object, generating at least one second vector based on at least one second grid and an upsampled first grid, decoding the first vector to generate a second IR of the 3D object, decoding the at least one second vector to generate at least one third IR of the 3D object, generating a composite IR of the 3D object based on the second IR of the 3D object and the at least one third IR of the 3D object, and generating a reconstructed volume representing the 3D object based on the composite IR of the 3D object.

### FIELD

Embodiments relate to encoding and decoding volumes, for example, three-dimensional (3D) images of 3D objects.

### BACKGROUND

Neural networks can be used for 3D object representation in applications such as compression, decompression, shape completion, neural rendering, super-resolution and/or the like. A compressed 3D object can be represented as at least one latent vector. The latent vector can be combined with a sampled 3D location as input to a decoder for decompression.

Neural network models can include global models and local models. The global models can generate (or include) a single latent vector used to represent the whole 3D object. The local models can divide the 3D space into regions and encode the 3D object within each region with a latent vector. These local representations can provide details within each region or local details. Global models and local models can be used separately or together (a hybrid model) to compress (encode) and decompress (decode) volumes (e.g., 3D images) representing 3D objects.

### SUMMARY

In a general aspect, a device, a system, a non-transitory computer-readable medium (having stored thereon computer executable program code which can be executed on a computer system), and/or a method can perform a process with a method including generating a first vector based on a first grid and a three-dimensional (3D) position associated with a first implicit representation (IR) of a 3D object, generating at least one second vector based on at least one second grid and an upsampled first grid, decoding the first vector to generate a second IR of the 3D object, decoding the at least one second vector to generate at least one third IR of the 3D object, generating a composite IR of the 3D object based on the second IR of the 3D object and the at least one third IR of the 3D object, and generating a reconstructed volume representing the 3D object based on the composite IR of the 3D object.

In another general aspect, a device, a system, a non-transitory computer-readable medium (having stored thereon computer executable program code which can be executed on a computer system), and/or a method can perform a process with a method including generating a first vector based on a first latent grid and a three-dimensional (3D) position associated with a signed distance function (SDF) representing a 3D object, generating at least one second vector based on at least one second latent grid and an upsampled first latent grid, decoding the first vector to generate a first SDF, decoding the at least one second vector to generate at least one second SDF, generating a composite SDF based on the first SDF and the at least one second SDF, and generating a reconstructed volume representing the 3D object based on the composite SDF.

In still another general aspect, a device, a system, a non-transitory computer-readable medium (having stored thereon computer executable program code which can be executed on a computer system), and/or a method can perform a process with a method including generating a feature set based on a representation of a three-dimensional (3D) object, generating a first grid of vectors based on the feature set, iteratively subdividing a volume associated with the feature set and generating at least one second grid of vectors based on a current iteration of the subdivided volume of the feature set, generating a latent code that includes a plurality of hierarchical layers including a first layer of the plurality of hierarchical layers includes the first grid and at least one second layer of the plurality of hierarchical layers includes the at least one second grid, generating a first vector based on the first grid of vectors and a 3D position associated with the 3D object, generating at least one second vector based on the at least one second grid of vectors and an upsampled first grid of vectors, decoding the first vector to generate a first partial representation of the 3D object, decoding the at least one second vector to generate at least one second partial representation of the 3D object, generating a composite representation of the 3D object based on the first partial representation of the 3D object and the at least one second partial representation of the 3D object, and generating a reconstructed volume representing the 3D object based on the composite representation of the 3D object.

Implementations can include one or more of the following features. For example, the first grid can include one vector representing a global shape of the 3D object. The at least one second grid can include two or more vectors each representing a portion of the 3D object. The at least one second grid can include a second grid and an nth grid, the at least one second grid can include two or more vectors each representing a portion of the 3D object, the second grid can include fewer vectors than the nth grid, and the second grid can include fewer details associated with the 3D object than the nth grid. The first IR of the 3D object can be missing a representation of a portion of the 3D object, and at least one of generating the second IR of the 3D object and generating the at least one third IR of the 3D object can include at least partially completing the missing representation of the portion of the 3D object.

Generating the at least one third IR of the 3D object can be performed by a decoder including a trained neural network, the neural network can be trained using latent code including dropped-out vectors associated with the at least one second grid, the dropped-out vectors simulating that the first IR of the 3D object is missing a representation of a portion of the 3D object, and the neural network is trained to complete the missing representation of the portion of the 3D object. The neural network can be trained using the reconstructed volume and a volume that the first IR of the 3D object is based on. Each of the at least one second vector can be generated based on a concatenation of a first sampled vector and a second sampled vector, the first sampled vector can be a trilinear interpolation of the upsampled first grid, and the second sampled vector can be a trilinear interpolation of a respective grid of the at least one second grid.

A latent code can include a plurality of hierarchical layers, a first layer of the plurality of hierarchical layers can include the first grid, and at least one second layer of the plurality of hierarchical layers can include the at least one second grid. The method can further include generating a feature set based on the first IR of the 3D object, generating the first grid based on the feature set, and iteratively subdividing a volume associated with the feature set and generating the at least one second grid based on a current iteration of the subdivided volume of the feature set. The number of iterations can define a resolution associated with the at least one third IR of the 3D object.

The method can further include a latent code that includes a plurality of hierarchical layers and a first layer of the plurality of hierarchical layers can include the first grid, and at least one second layer of the plurality of hierarchical layers can include the at least one second grid. The feature set can be generated using a neural network. The first IR of the 3D object can be missing a representation of a portion of the 3D object, the feature set is generated using a trained neural network, the neural network is trained to complete the missing representation of the portion of the 3D object while generating the feature set. The feature set can be generated using a trained neural network, the neural network can be trained using latent code including dropped-out vectors associated with the at least one second grid, the dropped-out vectors simulating that the first IR of the 3D object is missing a representation of a portion of the 3D object, and the neural network can be trained to complete the missing representation of the portion of the 3D object while generating the feature set.

The first grid can be generated using a trained neural network, the neural network can be trained using latent code including dropped-out vectors associated with the at least one second grid, the dropped-out vectors simulating that the first IR of the 3D object is missing a representation of a portion of the 3D object, and the neural network can be trained to complete the missing representation of the portion of the 3D object while generating the first latent grid. The at least one second grid can be generated using a trained neural network, the neural network can be trained using latent code including dropped-out vectors associated with the at least one second grid, the dropped-out vectors simulating that the IR of the 3D object is missing a representation of a portion of the 3D object, and the neural network can be trained to complete the missing representation of the portion of the 3D object while generating the at least one second grid.

The generating of the second IR of the 3D object can be performed by a decoder including a first trained neural network, the generating of the at least one third IR of the 3D object can be performed by the decoder including a second trained neural network, the first grid can be generated using a third trained neural network, the at least one second grid can be generated using at least one fourth trained neural network, the first neural network, the second neural network, the third neural network, and the at least one fourth trained neural network can be trained together using latent code including dropped-out vectors associated with the at least one second latent grid, the dropped-out vectors simulating that the IR of the 3D object is missing a representation of a portion of the 3D object, and the first neural network, the second neural network, the third neural network, and the at least one fourth trained neural network are trained together to complete the missing representation of the portion of the 3D object. The first vector can be a numeric value representing an attribute of the 3D object.

A grid can be a multi-dimensional array of numeric values each representing an attribute of the 3D object. The IR can include at least one observed variable that algorithmically infers at least one datum corresponding to a geometry of the 3D object. The method can further include generating the upsampled first grid by increasing at least one dimension associated with the first grid and extrapolating vector values for the increased at least one dimension based on vector values of the first grid. The composite IR can be a summing of the second IR of the 3D object with the at least one third IR of the 3D object. The generating of the reconstructed volume can include transforming the composite IR into renderable image data. The first IR can include a plurality of observed variables that algorithmically infers at least one datum corresponding to the 3D object, and the missing representation can be an absence of one or more of the plurality of observed variables.

The latent code can be a representation of compressed data corresponding to the 3D object, and the compressed data can include at least one a multi-dimensional array of vectors each representing an attribute of the 3D object. The latent code can include at least one multi-dimensional array of vectors each representing an attribute of the 3D object, and the dropped-out vectors can be vectors removed from the at least one multi-dimensional array of vectors. The latent code can include at least one multi-dimensional array of vectors each representing an attribute of the 3D object, and the hierarchical layers can be an organized structure of the at least one multi-dimensional array of vectors. The SDF can include at least one observed variable that algorithmically infers at least one datum corresponding to a geometry of the 3D object.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of an encoder/decoder system according to at least one example embodiment.

FIG. 2A illustrates a block diagram of training an encoder/decoder system according to at least one example embodiment.

FIG. 2B illustrates a block diagram of training a decoder according to at least one example embodiment.

FIG. 3 illustrates a block diagram of elements of a Multiresolution Deep Implicit Function (MDIF) according to at least one example embodiment.

FIG. 4A illustrates a block diagram of an encoder network according to at least one example embodiment.

FIG. 4B illustrates a block diagram of a pre-decoder network according to at least one example embodiment.

FIG. 5 illustrates a flow diagram of training an encoder/decoder system according to at least one example embodiment.

FIG. 6 illustrates a diagram of a decoder-only inference mode according to at least one example embodiment.

FIG. 7 illustrates a diagram of generating a reconstructed volume according to at least one example embodiment.

FIG. 8A illustrates a block diagram of an encoder system according to at least one example embodiment.

FIG. 8B illustrates a block diagram of a decoder system according to at least one example embodiment.

FIG. 9 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the relative thicknesses and positioning structural elements may be reduced or exaggerated for clarity. The use of similar or identical reference numbers in the various drawings is intended to indicate the presence of a similar or identical element or feature.

### DETAILED DESCRIPTION

Deep implicit functions (DIF) can be used as a three-dimensional (3D) geometry representation. A DIF can be used for 3D object representation in applications such as compression, shape completion, neural rendering, and super-resolution. In contrast to explicit representations such as point clouds, voxels, or meshes, a 3D object, using a DIF a 3D object can be represented as a compact latent vector (e.g., an implicit function). The compact latent vector can be combined with a sampled 3D location as input to a decoder in order to evaluate an implicit function for surface reconstruction.

DIF methods can be classified as global DIF models and local DIF models. The global DIF models can generate (or include) a single latent vector used to represent the whole 3D object. Global DIF models can include DeepSDF, IM-Net, OccNet, DISN, and Deep Level sets. The global DIF models can learn to encode a global shape in a compact latent space, which can then be leveraged to fulfill tasks such as shape completion. However, due to the limited capacity of the latent space and the global nature of these approaches, global methods usually lack fine-grained detail.

The local DIF models (e.g., Local Implicit Grid and Deep Local Shapes or LDIF) can divide the 3D space into regions and encode the shape within each region with a latent vector. These local representations can provide details within each region or local details. However, the local DIF models do not model a global prior, which can be needed for operations such as shape completion. For example, every local region is encoded separately, and some regions may not have any observed points inside them. Therefore, local DIF models can be insufficient for shape completion. Some DIF methods overcome this issue by using a hybrid model including the use of a global encoder to decompose an observation into local regions. However, the number and/or size of the local regions should be chosen before training begins limiting the accuracy and generality of hybrid models.

Accordingly, existing techniques have the problem of lacking at least one of local details and or global information needed for 3D object completion when reconstructing a volume or an image using a compact latent vector. Example implementations can solve this problem using a DIF that has three properties: (1) represent 3D objects with arbitrarily fine details (adding more bits to the representation provides more details), (2) encode 3D object priors at all levels of detail, and (3) support decoder-only 3D object reconstruction by optimizing latent codes at inference. These properties can enable (or help enable) accurate reconstruction of 3D objects from partial observations (e.g., volumes or images needing 3D object completion).

An example implementation can include representing a 3D object as a multiresolution hierarchy of grids, latent vectors, or latent grid of vectors. Each hierarchical level can encode a different frequency of an implicit function. The multiresolution hierarchy of latent vectors can be generated using a Multiresolution Deep Implicit Function (MDIF). In some implementations, the higher hierarchical levels of the representation can provide the global 3D object information and the lower hierarchical levels can provide fine details. The decoder (also an element of MDIF) for every hierarchical level can produce a residual with respect to the parent level. The MDIF can simplify learning of fine detail and can enable progressive decoding to achieve arbitrary levels of detail.

In addition, a dropout technique can be applied to the grid, enabling the decoder to learn to complete 3D objects or shapes. Training just the decoder can enable decoder-only 3D object or shape reconstruction and completion, while also supporting the standard encoder/decoder inference. As a result, MDIF can be capable of supporting multiple reconstruction modalities for 3D object or shape reconstruction and completion.

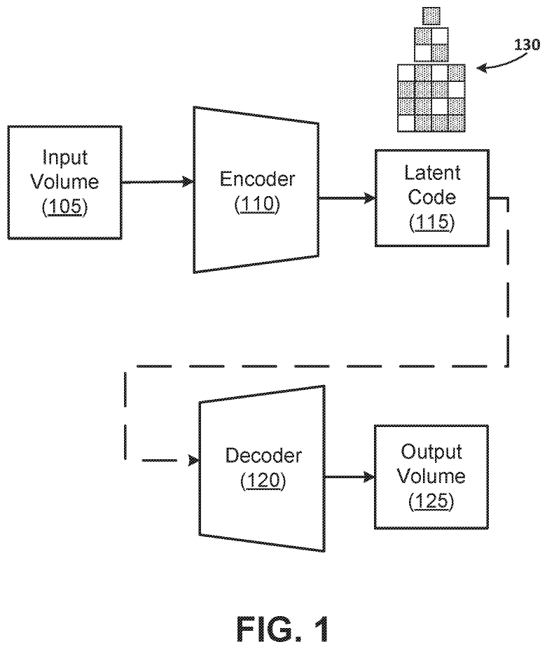

The benefit of example implementations including the MDIF can include at least, (1) the model can be trained efficiently in an encoder/decoder manner, while supporting both encoder/decoder mode and decoder-only mode during inference, (2) the model can be trained with complete shapes and using the dropout technique, the model can support both complete and partial shapes as input during inference, and (3) the decoder side can be decomposed into multiple levels, hence supporting multi-resolution rendering. FIG. 1 can be used to generally describe the MDIF encoder/decoder system.

FIG. 1 illustrates a block diagram of an encoder/decoder system according to at least one example embodiment. As shown in FIG. 1, the encoder/decoder system can include an input volume 105, an encoder 110, a latent code 115 block, a decoder 120, and an output volume 125.

The input volume 105 can be data representing a 3D object. For example, input volume 105 can be a volume (e.g., a 3D image) representation of a 3D object. The input volume 105 can be a point cloud, a voxel, a mesh, and/or the like. The input volume 105 can be incomplete data because at least one portion of the 3D object is not represented in the input volume 105. For example, a 3D object could be a chair. The chair could be used in an augmented reality application. The input volume 105 can be a representation of the chair missing a portion of one of the chair legs. In other words, at least one pixel (e.g., representing a point, a voxel, and/or the like) can be missing from the volume. Alternatively (or in addition), at least one pixel's color can be incorrect in the volume. A pixel's color can be incorrect with respect to surrounding pixels (e.g., black or white when the surrounding pixels are red). The chair could be missing the portion of one of the chairs legs because of a 3D image capture error, a corrupt file, and/or the like.

The encoder 110 can include a trained neural network configured to generate the latent code 115. Generating the latent code 115 can sometimes be called an inference. The latent code 115 can be at least one grid (e.g., a 3D grid) including at least one vector (sometimes called a grid of vectors or grid of latent vectors) that describes the input volume 105. Vector blocks 130 illustrates a portion of the latent code 115 including grids with blocks representing vectors (filled-in or shaded blocks) and blocks representing missing vectors (empty or white blocks). The missing vectors can represent the at least one portion of the 3D object that is not represented in the input volume 105. However, if the input volume 105 were a complete representation of the 3D object, the vector block 130 would not include any missing vectors.

In an example implementation, the encoder 110 can generate latent code that implicitly represents the 3D surfaces of the 3D object represented by the input volume 105. The encoder 110 can be configured to generate a latent representation (LR) of the 3D object to represent the geometry (and/or a portion of the geometry) of the 3D object represented by the input volume 105. In an example implementation, the input volume 105 can be an implicit representation (e.g., SDF) to the values (e.g., image, point cloud, voxels, pixels and/or the like) of an image corresponding to a surface of the 3D object. For example, the implicit representation (IR) can be an algorithm (e.g., algebraic expression) used to calculate volume variables corresponding to a geometry of the 3D object. In an example implementation, the input volume 105 format can be an SDF. An SDF can be a signed distance to the closest surface (positive on the outside and negative on the inside) of the geometry. The encoder 110 can include a neural network that can be trained to classify variables associated with the IR of the 3D object. For example, the encoder 110 can include a neural network that can be trained to classify continuous points in 3D as inside or outside the surface of the SDF. The classified continuous points can be operated on by another trained neural network to generate (e.g., infer) the latent code 115.

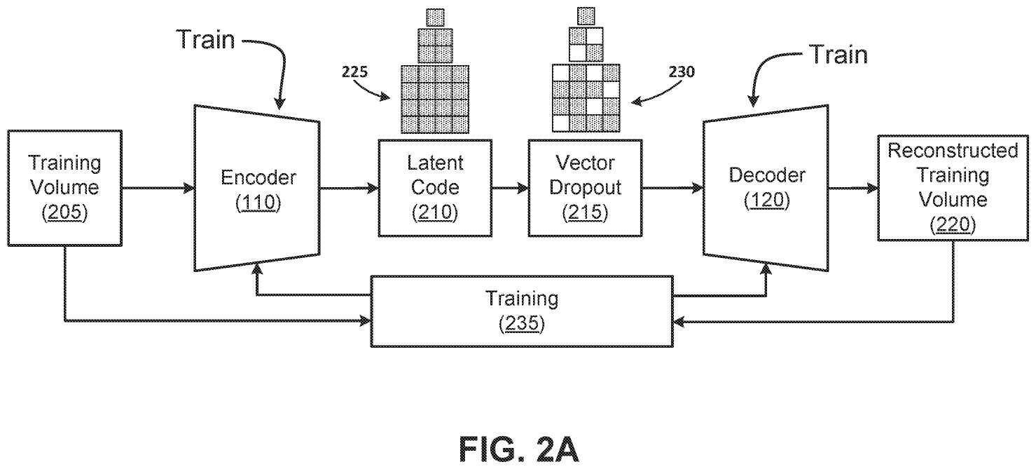

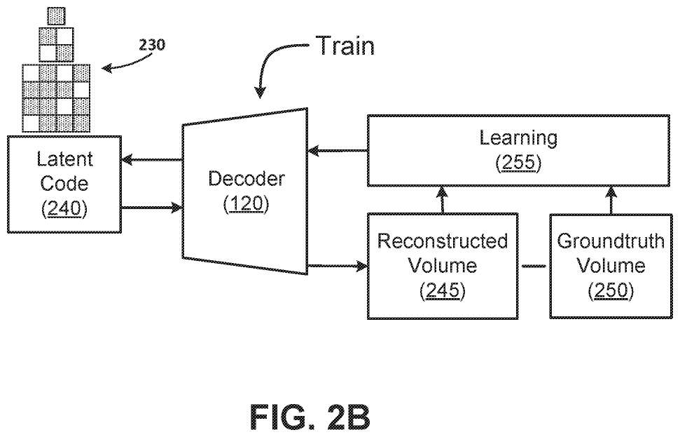

The decoder 120 can include a trained neural network configured to generate the output volume 125 based on the latent code 115. The dashed line in FIG. 1 is used to indicate that the encoder 110 and the decoder 120 can operate together as a pair or the encoder 110 and the decoder 120 can operate independently. The encoder 110 and the decoder 120 can be trained together (e.g., as an autoencoder). Alternatively, the decoder 120 can be trained alone (e.g., independent of the encoder 110). Accordingly, the output volume 125 can be generated with 3D object completion being performed by both the encoder 110 and the decoder 120 or with 3D object completion being performed by the decoder 120 alone. The output volume 125 can include the at least one portion of the 3D object that is not represented in the input volume 105 based on the 3D object completion of both the encoder 110 and the decoder 120 or the 3D object completion of the decoder 120 alone. FIG. 2A illustrates 3D object completion with training of both the encoder 110 and the decoder 120 and FIG. 2B illustrates the 3D object completion with training of the decoder 120 alone.

FIG. 2A illustrates a block diagram illustrating training of an encoder/decoder system according to at least one example embodiment. As shown in FIG. 2A, training an encoder/decoder system can include use of a training volume 205, the encoder 110, a latent code 210 block, a vector dropout 215 block, the decoder 120, a reconstructed training volume 220, and a training 235 block.

In an example implementation, the encoder 110 can generate the latent code 210 based on the training volume 205. The training volume 205 can be an image representation of a 3D object. The training volume 205 can be a point cloud, a voxel, a mesh, and/or the like. The training volume 205 can be a complete representation of the 3D object. A portion of the latent code 210 can include vector blocks 225 including grids with blocks representing vectors (filled-in or shaded blocks). In other words, the training volume 205 is not missing any portion of the 3D object.

The vector dropout 215 can be configured to remove at least one vector from the latent code 210. In other words, the vector dropout 215 can cause the simulation of an incomplete representation of the 3D object for training purposes. Vector blocks 230 illustrates latent code 210 with blocks representing vectors (filled-in or shaded blocks) and blocks representing missing vectors (empty or white blocks). The missing vectors can represent portions of the training volume 205 that have been removed in order to simulate an incomplete representation of the 3D object (represented by the training volume 205) for training purposes.

The decoder 120 can be a trained neural network configured to generate the reconstructed training volume 220 based on latent code 210 with the vector dropout 215. The encoder 110 and the decoder 120 can be trained together (e.g., as an autoencoder). Accordingly, the reconstructed training volume 220 can be generated with 3D object completion or shape completion being performed by both the encoder 110 and the decoder 120. The reconstructed training volume 220 can include the at least one portion of the 3D object that is not represented in the latent code 210 with the vector dropout 215 based on the 3D object completion of both the encoder 110 and the decoder 120.

The training 235 block can be configured to cause the training of the encoder 110 and the decoder 120. In an example implementation, the training volume 205 includes a complete representation of the associated 3D object. Therefore, the training volume 205 can be used for training 235 as the ground truth for training. In other words, the training 235 can compare the reconstructed training volume 220 to the training volume 205 in order to determine the difference between the two volumes (e.g., how well 3D object completion is implemented). Then training 235 of the encoder 110 and the decoder 120 can be trained together to minimize the difference. In other words, the encoder 110 and the decoder 120 can be trained on how well the encoder 110 and the decoder 120 perform 3D object completion based on the difference between the reconstructed training volume 220 and the training volume 205. A loss can be generated based on the difference between the training volume 205 and the reconstructed training volume 220. Encoder/decoder training 235 iterations can continue until the loss is minimized and/or until loss does not change significantly from iteration to iteration.

FIG. 2B illustrates a block diagram illustrating training of a decoder according to at least one example embodiment. As shown in FIG. 2B, training a decoder system can include a latent code 240, the decoder 120, a reconstructed volume 245, a groundtruth volume 250, and a learning 255 block.

The latent code 240 can be configured to generate and/or include latent code representing a volume. Initially, the latent code 240 can include randomly generated latent code in order to cause the simulation of an incomplete representation of the 3D object for training purposes. Vector blocks 230 illustrates latent code with blocks representing vectors (filled-in or shaded blocks) and blocks representing missing vectors (empty or white blocks). The missing vectors can represent portions of a volume 205 that has been removed in order to simulate an incomplete representation of the 3D object for training purposes.

The decoder 120 can be a trained neural network configured to generate the reconstructed volume 245 based on the latent code with missing vectors. According to an example implementation, the decoder 120 can be trained to modify latent code to complete a volume (e.g., a volume with missing vectors). Accordingly, the reconstructed volume 245 can be generated with 3D object completion being performed by only the decoder 120. The reconstructed volume 245 can include at least one portion of the 3D object that is not represented in the initial latent code 240 based on the 3D object completion performed by the decoder 120.

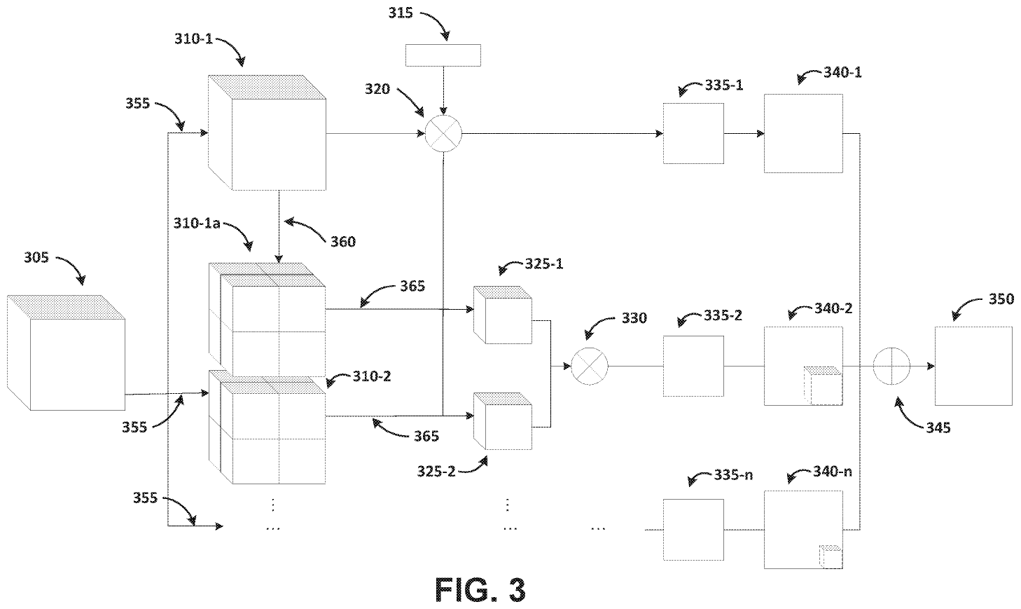

The learning 255 block can be configured to cause the training of the decoder 120 (independent of an encoder). In an example implementation, the groundtruth volume 250 includes a complete representation of the associated 3D object. Therefore, the groundtruth volume 250 can be used for training by the learning 255 block. For example, the learning 255 block can compare the reconstructed volume 245 to the groundtruth volume 250 in order to determine the difference between the two volumes. Then the training of the decoder 120 can include training the decoder 120 (e.g., deep learning) to modify latent code to minimize the difference between the two volumes. In other words, the decoder 120 can be trained on how well the decoder 120 performs 3D object completion or shape completion based on the difference between the reconstructed volume 245 and the groundtruth volume 250. A loss can be generated based on the difference between the groundtruth volume 250 and the reconstructed volume 245. In an example implementation, the learning 255 block can be configured to generate a gradient based on the difference between the groundtruth volume 250 and the reconstructed volume 245 (e.g., based on the loss). The decoder 120 can learn to modify latent code using the gradient. Decoder training iterations can continue until the loss is minimized and/or until loss does not change significantly from iteration to iteration. FIG. 3 can be used to describe portions (e.g., the neural network) of the encoder and decoder described above.

FIG. 3 illustrates a block diagram of elements of a Multiresolution Deep Implicit Function (MDIF) according to at least one example embodiment. As shown in FIG. 3, the elements of an MDIF can include a feature 305 block, a portion of a latent code including grids 310-1, 310-1a, 310-2, vectors 325-1, 325-2, a 3D position 315 block, concatenation 320, 330 blocks, decoder 335-1, 335-2, 335-n, a global IR of a 3D object 340-1 block and residual IR of the 3D object 340-2, 340-n blocks, a sum 345 block, and a 3D object 350 block.

Prior to encoding a volume or an image (e.g., a point cloud, a voxel, a mesh, and/or the like) representing a 3D object, the MDIF can include the functionality to convert the volume or image to an implicit representation (IR) representing the 3D object (e.g., an SDF). For example, an SDF can represent the signed distance to the closest surface (positive on the outside and negative on the inside) of points (or voxels and the like) of the volume representing the 3D object. The SDF can be a level set defined as:

$$V ( τ ) = \{ x : S ( x ) = τ \}$$

where:
V is the volume containing the shape,
x is a 3D point inside V, and
S: [symbol] ³→ [symbol] is the SDF function.

S(x) can be used to represent the SDF value of a particular point x, and V(0) to represent the surface or zero-crossing. An N-level version of S can be defined as {Sₙ} n=0 . . . N−1, where each level represents different frequency of details from low to high. To construct the level set, volume V can be subdivided into an N-level octree to construct the N-level version of S. Unlike conventional octrees, where only non-empty cells are subdivided, an example implementation of an octree can be balanced because completing a partial observation is a target scenarios. For level 0 (the coarsest level), geometry can be represented as SDF S₀; for level n>0, a residual Rₙ=Sₙ−Sₙ₋₁ can be used to capture finer details. The final SDF reconstruction can be defined as S₀+Σₙ₌₁^{N-1} Rₙ. In example implementations, inferring residuals can be used instead of directly regressing the SDF. Accordingly, in an MDIF, the volume or image representing the 3D object can be converted to an SDF as described above which is then used as an input to an encoder.

In FIG. 3, the encoder (e.g., encoder 110 not shown) can extract the feature 305 block from the input IR of the 3D object (e.g., SDF) that has been generated based on the volume (e.g., input volume 105 or training volume 205) representing a 3D object. The feature 305 block can be or include a global feature. Then the feature 305 block is encoded into different levels of grids 310-1, 310-2 using 3D convolution layers 355. In an example implementation, at level 0, there is only one vector in the grid 310-1 representing the global shape of the 3D object. In addition, at level 1 (and on to level n), there are a plurality of vectors (corresponding to a subdivided IR of the 3D object) in grid 310-2 representing a plurality of shapes each corresponding to a portion of the 3D object.

In a decoder (e.g., decoder 120 not shown), example implementations can include one decoder 335-1, 335-2, 335-n per level to support decompressing (or generating) different resolutions shown as residual IR of the 3D object 340-2, 340-n blocks in addition to decompressing (or generating) a global resolution shown as global IR of the 3D object 340-1 block. The decoder 335-1, 335-2, 335-n blocks can include several fully connected layers of an implicit field decoder (e.g., IM-Net) to generate shapes (e.g., representing the 3D object and/or a portion of the 3D object). For example, an implicit field can assign a value to each point in a 3D space such that a shape can be extracted as an iso-surface. The decoder (e.g., decoder 120) can include a neural network that can be trained to assign the value using a binary classifier. In addition, for each point coordinate the decoder can generate a value indicating whether the point is outside a shape or inside the shape. The grid 310-1 and 310-2 can be a portion of a latent code whereas grid 310-1a can be generated based on (e.g., upsampled) grid 310-1

At the global level (or level 0 (or n=0)) including grid 310-1 representing the global shape of the 3D object, the grid 310-1 includes one vector (or latent vector). Therefore, the input to decoder 335-1 can be based on grid 310-1 and a 3D position associated with 3D position 315 block (as a 3D position determined from the input IR of the 3D object). The decoder 335-1 can generate (e.g., infer) the IR of the 3D object value at that point. For higher levels (n>0), the input of decoder 335-n can include two parts. The first part can use trilinear interpolation 365 to generate a sample vector 325-2 from the grid 310-2 the corresponding level (n>0), based on the 3D position associated with 3D position 315. For the second part, a deconvolution 360 can be applied to upsample the lower level vector (e.g., n=0 for n=1, etc.) to a grid 310-1a, which has the same spatial resolution as vector grid 310-2. Then trilinear interpolation 365 can be applied to generate a sample vector 325-1 from grid 310-1a. This allows the decoder 335-2 (or 335-n) to have access to the global context to better decode local details. This can be referenced as a formula (or algorithm using an SDF as the IR of the 3D object),

$${D}_{0} ( {z}_{0} , x ) = {S}_{0} ;$$

$${D}_{n} ( {z}_{n} , {z}_{n}^{′} ) = {R}_{n} ; n > 0 ,$$

where:
D₀ is the global level decoder;
Dₙ is the level n decoder;
z₀ is the global vector;
zₙ is trilinear sampled vector of level n;
z′ₙ is trilinear sampled vector of the deconvolved level n−1 (n>0);
S₀ is the global level SDF;
Rₙ is residual SDF at level n;
x is a 3D position determined from the input SDF; and
n is a hierarchical level.

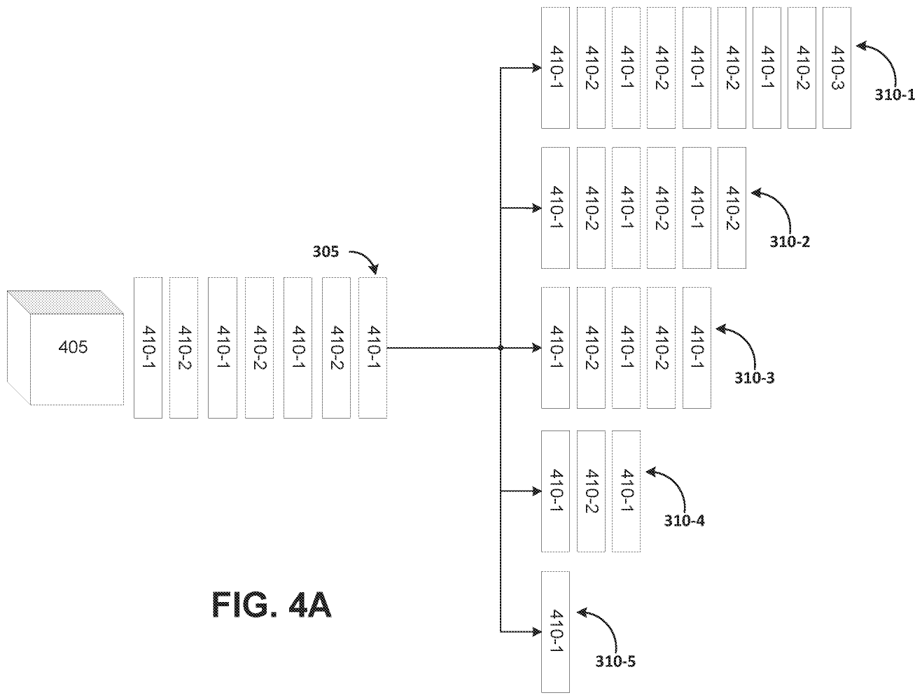

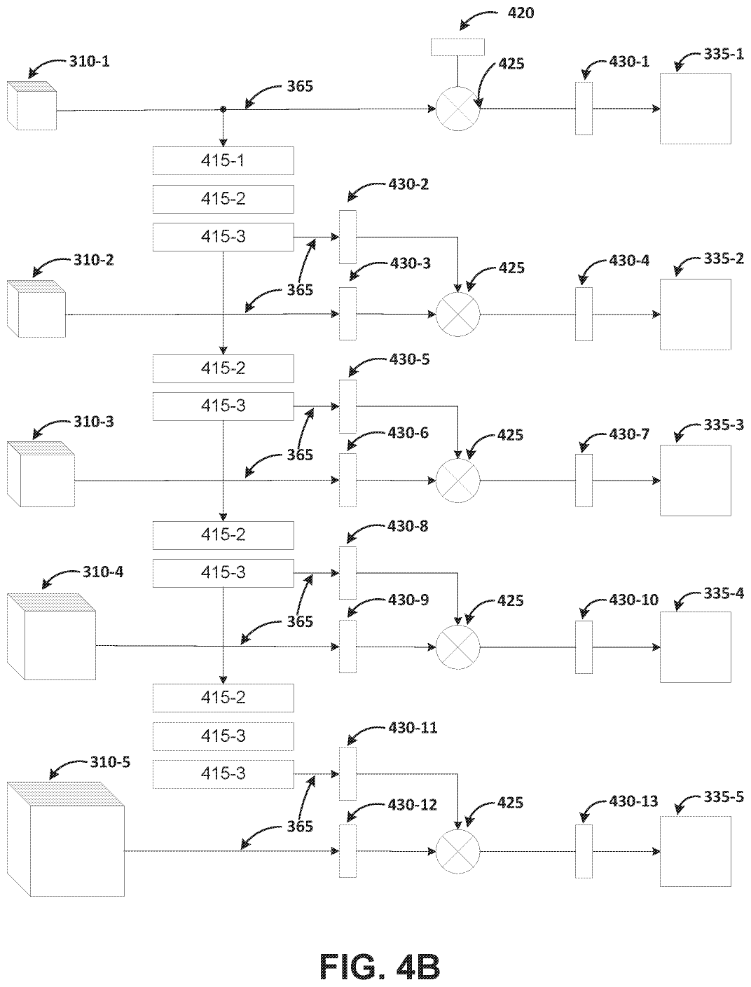

For n>0, the decoders 335-2, 335-n do not take 3D points x as input, because zₙ and z′ₙ are functions of x via trilinear interpolation. Finally, since Dₙ>0 predicts residual R, the outputs of all levels are aggregated to have the final SDF shown as a 3D object 350 block. Generating a latent code (e.g., a compressed representation of the volume representing the 3D object) based on an SDF is described below with regard to FIG. 4A and pre-decoding the latent code as input into decoders to generate a reconstructed volume representing the 3D object is described below with regard to FIG. 4B.

FIG. 4A illustrates a block diagram of an encoder network according to at least one example embodiment. For example, FIG. 4A can illustrate an architecture associated with the encoder 110. As shown in FIG. 4A, the encoder network can include an IR of the 3D object 405 and a plurality of convolution 410-1, 410-2, 410-3 blocks. In an example implementation, the plurality of convolutions 410-1, 410-2, and 410-3 can be 3D convolutions with leaky ReLu, convolution 410-1 can have a 3×3×3 kernel size and a stride of 1, convolution 410-2 can have a 3×3×3 kernel size and a stride of 2, and convolution 410-3 can have a 1×1×1 kernel size and a stride of 1. Each row of convolutions can generate a block illustrated in FIG. 3. As shown in FIG. 4A a row of convolutions can generate the feature 305 block. The remaining rows of convolutions can generate the latent code including grids 310-1, 310-2, 310-3, 310-4, and 310-5 (noting that grids 310-4 and 310-5 are not illustrated in FIG. 3).

As discussed above, prior to encoding a volume (e.g., an image, a point cloud, a voxel, a mesh, and/or the like) representing a 3D object, the volume can be converted to an IR of the 3D object. Therefore, the IR of the 3D object 405 can represent a 3D object. More specifically, the IR of the 3D object 405 can represent or infer a plurality of points along the surface of the 3D object. The IR of the 3D object 405 can be operated on by a plurality of convolutions 410-1, 410-2 in sequence to generate the feature 305 block. In an example implementation, the IR of the 3D object 405 (as an input SDF (S)) can be normalized to a fixed size (e.g., 128³×1). Accordingly, after being operated on by the plurality of convolutions 410-1, 410-2, the feature 305 block can have a fixed size (e.g., 16³×32) based on the normalized IR of the 3D object 405 and the kernel size and stride of the plurality of convolutions 410-1, 410-2.

As discussed above, in an example implementation (having hierarchical levels), at level 0, there is only one vector in grid 310-1 representing the global shape of the 3D object. In addition, at level 1 (and on to level n), there are a plurality of vectors in grid 310-2 (continuing from grid 310-3 to grid 310-n) representing a plurality of shapes each corresponding to a portion of the 3D object. Accordingly, the features 305 block can be operated on by the plurality of convolutions 410-1, 410-2, 410-3 to generate grid 310-1 (including one vector). In an example implementation, the feature 305 block can have a fixed size (e.g., 16³×32) based on the normalized IR of the 3D object 405 and the grid 310-1 (level 0 (or Z₀) representing the global shape of the 3D object) can have a size (e.g., 1³×512) based on the feature 305 block and the kernel size and stride of the plurality of convolutions 410-1, 410-2, 410-3.

Continuing the example, the feature 305 block can be operated on by the plurality of convolutions 410-1, 410-2 to generate grid 310-2. The feature 305 block can have a fixed size (e.g., 16³×32) based on the normalized IR of the 3D object 405 and the grid 310-2 (level 1 (or Z₁) representing two or more portions of the shape of the 3D object) can have a size (e.g., 2³×64) based on the feature 305 block and the kernel size and stride of the plurality of convolutions 410-1, 410-2. The feature 305 block can be operated on by the plurality of convolutions 410-1, 410-2 to generate grid 310-3. The feature 305 block can have a fixed size (e.g., 16³×32) based on the normalized IR of the 3D object 405 and the grid 310-3 (level 2 (or Z₂) representing two or more portions of the shape of the 3D object) can have a size (e.g., 4³×32) based on the feature 305 block and the kernel size and stride of the plurality of convolutions 410-1, 410-2.

The feature 305 block can be operated on by the plurality of convolutions 410-1, 410-2 to generate grids 310-4. The feature 305 block can have a fixed size (e.g., 16³×32) based on the normalized IR of the 3D object 405 and the grid 310-4 (level 3 (or Z₃) representing two or more portions of the shape of the 3D object) can have a size (e.g., 8³×16) based on the feature 305 block and the kernel size and stride of the plurality of convolutions 410-1, 410-2. The feature 305 block can be operated on by the plurality of convolutions 410-1, 410-2 to generate grid 310-5. The feature 305 block can have a fixed size (e.g., 16³×32) based on the normalized IR of the 3D object 405 and the grid 310-5 (level 4 (or Z₄) representing two or more portions of the shape of the 3D object) can have a size (e.g., 16³×8) based on the feature 305 block and the kernel size and stride of the plurality of convolutions 410-1, 410-2.

Training the encoder can include modifying weights associated with at least one of convolution 410-1, 410-2, and 410-3. The encoder can be trained for 3D object completion or shape completion. Although level 0 and generating four additional levels are describe, example implementations can include generating less than four additional levels or more than four additional levels.

FIG. 4B illustrates a block diagram of a pre-decoder network according to at least one example embodiment. For example, FIG. 4B can illustrate an architecture associated with the decoder 120. As shown in FIG. 4B, the pre-decoder can include the grids 310-1, 310-2, 310-3, 310-4, 310-5, a plurality of convolutions 415-1, 415-2, 415-3, a plurality of concatenation 425 blocks, a plurality of vectors 430-1, 430-2, 430-3, 430-4, 430-5, 430-6, 430-7, 430-8, 430-9, 430-10, 430-11, 430-12, 430-13, and the decoders 335-1, 335-2, 335-3, 335-4, 335-5 (noting that the decoders 335-3, 335-4, and 335-5 are not shown in FIG. 3). In an example implementation, the plurality of convolutions 415-1, 415-2, and 415-3 can be 3D transposed convolutions with leaky ReLu, convolution 415-1 can have a 1×1×1 kernel size and a stride of 1, convolution 415-2 can have a 4×4×4 kernel size and a stride of 2, and convolution 415-3 can have a 3×3×3 kernel size and a stride of 1.

Continuing the example described with regard to FIG. 4A, the grid 310-1 (level 0 (or Z₀) representing the global shape of the 3D object) can have a size (e.g., 1³×512), the grid 310-2 (level 1 (or Z₁) representing two or more portions of the shape of the 3D object) can have a size (e.g., 2³×64), the grid 310-3 (level 2 (or Z₂) representing two or more portions of the shape of the 3D object) can have a size (e.g., 4³×32), the grid 310-4 (level 3 (or Z₃) representing two or more portions of the shape of the 3D object) can have a size (e.g., 8³×16), and the grid 310-5 (level 4 (or Z₄) representing two or more portions of the shape of the 3D object) can have a size (e.g., 16³×8). The size of a grid can indicate a number of vectors (e.g., latent vectors) which also indicates convolutional division of the features 305 block into two or more portions (e.g., two or more portions of the 3D object).

The pre-decoder can be configured to generate the input to decoders. For example, as shown in FIG. 4B, the input to decoder 335-1 can be generated based on the grid 310-1, the input to decoder 335-2 can be generated based on the grid 310-1 and the grid 310-2, the input to decoder 335-3 can be generated based on the grid 310-1 and the grid 310-3, the input to decoder 335-4 can be generated based on the grid 310-1 and the grid 310-4, and the input to decoder 335-5 can be generated based on the grid 310-1 and the grid 310-5.

The input to decoder 335-1 can be generated based on a concatenation 425 of the grid 310-1 and a 3D position associated with 3D position 420 block (as a 3D position determined from the input IR of the 3D object). The input to decoder 335-1 can be vector 430-1. Continuing the example above, vector 430-1 can have a size (e.g., 1³×515) based on the size (e.g., 1³×512) of grid 310-1 and the size (e.g., 1³×3) of the 3D position 420 block.

The input to decoder 335-2 can be generated based on a concatenation 425 of the vector 430-2 and the vector 430-3. The input to decoder 335-2 can be vector 430-4. The vector 430-3 can be generated based on a trilinear interpolation 365 from the grid 310-2. The trilinear interpolation 365 can generate a sample vector (e.g., vector 430-3) from a vector grid (e.g., grid 310-2) at the corresponding level (n>0), based on a 3D position (e.g., associated with 3D position 420). The vector 430-2 can be generated based on grid 310-1 being operated on by the convolutions 415-1, 415-2 and 415-3 (e.g., each as a deconvolution) applied to upsample the grid 310-1. The resultant upsampled grid 310-1 can have a same spatial resolution as grid 310-2. The vector 430-2 can be further generated based on a trilinear interpolation 365 from resultant upsampled grid 310-1. This can allow for the decoder 335-2 to have access to the global context to better decode local details. Continuing the example above, vector 430-4 can have a size (e.g., 1³×320) based on the size (e.g., 1³×256) of vector 430-2 and the size (e.g., 1³×64) of the vector 430-3. The size (e.g., 1³×256) of vector 430-2 can be based on the size (e.g., 2³×256) of upsampled grid 310-1 and the size (e.g., 1³×64) of the vector 430-3 can be based on the size (e.g., 2³×64) of grid 310-2.

The input to decoder 335-3 can be generated based on a concatenation 425 of the vector 430-5 and the vector 430-6. The input to decoder 335-3 can be vector 430-7. The vector 430-6 can be generated based on a trilinear interpolation 365 from the grid 310-3. The vector 430-5 can be generated based on grid 310-1 being operated on by the convolutions 415-1, 415-2 and 415-3 the result of which is further operated on by convolutions 415-2 and 415-3 (e.g., each as a deconvolution) applied to upsample the grid 310-1. The resultant upsampled grid 310-1 can have a same spatial resolution as grid 310-3. The vector 430-5 can be further generated based on a trilinear interpolation 365 from resultant upsampled grid 310-1. This can allow for the decoder 335-3 to have access to the global context to better decode local details. Continuing the example above, vector 430-7 can have a size (e.g., 1³×160) based on the size (e.g., 1³×128) of vector 430-5 and the size (e.g., 1³×32) of the vector 430-6. The size (e.g., 1³×128) of vector 430-5 can be based on the size (e.g., 4³×128) of upsampled grid 310-1 and the size (e.g., 1³×32) of the vector 430-6 can be based on the size (e.g., 4³×32) of grid 310-3.

The input to decoder 335-4 can be generated based on a concatenation 425 of the vector 430-8 and the vector 430-9. The input to decoder 335-4 can be vector 430-10. The vector 430-9 can be generated based on a trilinear interpolation 365 from the grid 310-4. The vector 430-8 can be generated based on the grid 310-1 being operated on by the convolutions 415-1, 415-2,415-3, 415-2 and 415-3 the result of which is further operated on by convolutions 415-2 and 415-3 (e.g., each as a deconvolution) applied to upsample the grid 310-1. The resultant upsampled grid 310-1 can have a same spatial resolution as grid 310-4. The vector 430-8 can be further generated based on a trilinear interpolation 365 from resultant upsampled grid 310-1. This can allow for the decoder 335-4 to have access to the global context to better decode local details. Continuing the example above, vector 430-10 can have a size (e.g., 1³×80) based on the size (e.g., 1³×64) of vector 430-8 and the size (e.g., 1³×26) of the vector 430-9. The size (e.g., 1³×64) of vector 430-8 can be based on the size (e.g., 8³×64) of upsampled grid 310-1 and the size (e.g., 1³×16) of the vector 430-9 can be based on the size (e.g., 8³×16) of grid 310-4.

The input to decoder 335-5 can be generated based on a concatenation 425 of the vector 430-11 and the vector 430-12. The input to decoder 335-5 can be vector 430-13. The vector 430-12 can be generated based on a trilinear interpolation 365 from the grid 310-5. The vector 430-11 can be generated based on grid 310-1 being operated on by the convolutions 415-1, 415-2, 415-3, 415-2, 415-3 the result of which is further operated on by convolutions 415-2 and 415-3 (e.g., each as a deconvolution) applied to upsample the grid 310-1. The resultant upsampled grid 310-1 can have a same spatial resolution as grid 310-5. The vector 430-11 can be further generated based on a trilinear interpolation 365 from resultant upsampled grid 310-1. This can allow for the decoder 335-5 to have access to the global context to better decode local details. Continuing the example above, vector 430-13 can have a size (e.g., 1³×80) based on the size (e.g., 1³×64) of vector 430-11 and the size (e.g., 1³×26) of the vector 430-12. The size (e.g., 1³×64) of vector 430-11 can be based on the size (e.g., 8³×64) of upsampled grid 310-1 and the size (e.g., 1³×16) of the vector 430-12 can be based on the size (e.g., 8³×16) of grid 310-5.

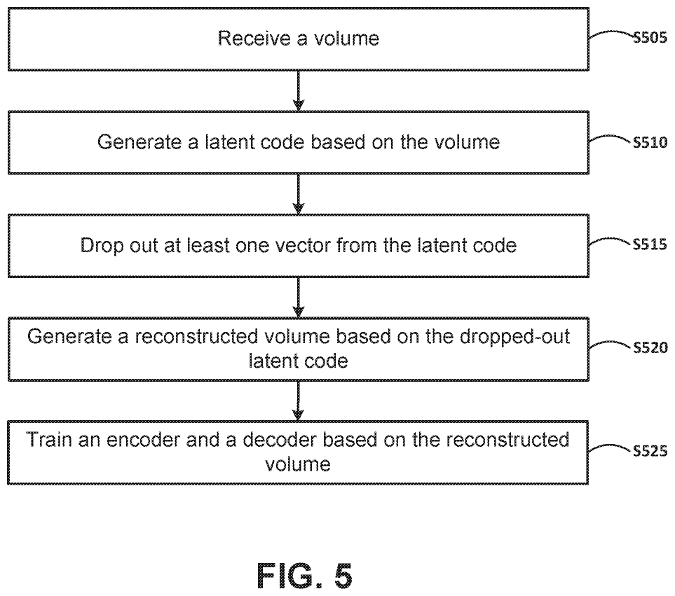

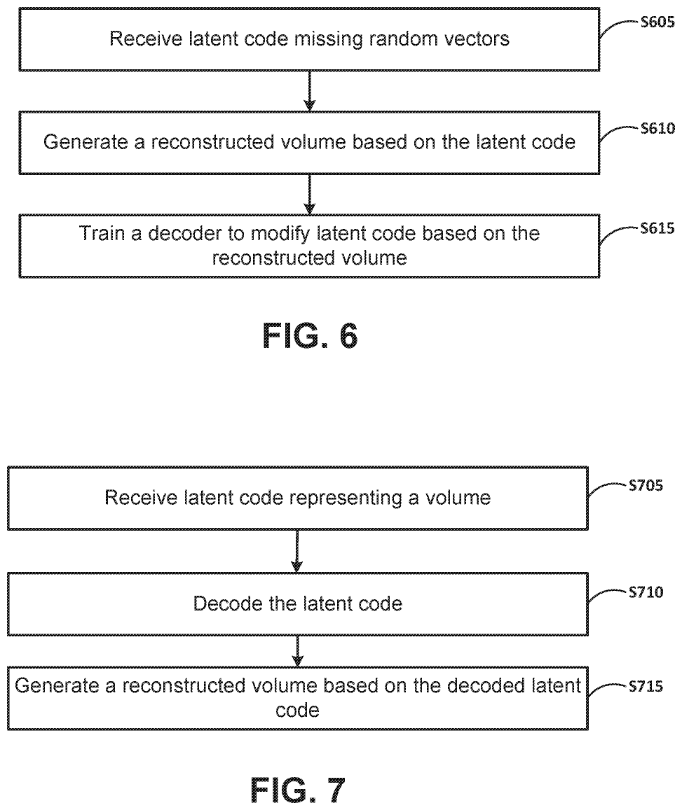

Training the decoder can include modifying weights associated with at least one of convolution 415-1, 415-2, and 415-3. The decoder can be trained for 3D object completion or shape completion. Training the above described neural networks implementing the encoder and the decoder can be described with regard to FIGS 4 and 5. An example MDIF can be trained end-to-end as an encoder/decoder (see FIG. 2A) as described with regard to FIG. 5 or as a decoder-only (see FIG. 2B) as described with regard to FIG. 6. In order to clarify terms used herein, encoding and decoding can sometimes be called an inference. An encoder inference can generate a latent code. A latent code can include at least one grid. A grid can include at least one vector. A decoder inference can decode a grid to generate information used to reconstruct a volume (e.g., a volume representing a 3D object).

FIG. 5 illustrates a flow diagram of training an encoder/decoder system according to at least one example embodiment. As shown in FIG. 5, in step S505 a volume (e.g., a training volume) is received. The volume can be an image, a point cloud, a voxel, a mesh, and/or the like. The volume can be an image representation of a 3D object. In example implementations, the volume is converted (as described above) to an IR of the 3D object. In some implementations, the volume is received as an IR of the 3D object.

In step S510 a latent code is generated based on the volume. For example, the latent code can include hierarchical levels of grids each including at least one vector. A first level of the hierarchical levels of grids can be a global level (or level 0 (or n=0)) including one vector representing the global shape of the 3D object. A second level to an nth level of the hierarchical levels of grids can be residual levels (or level n: n>0) each including two or more vectors representing a portion of the shape of the 3D object. In an example implementation, a feature block can be generated based on the IR of the 3D object using a neural network encoder. Then, the grid for each level can be generated based on the feature block using a neural network for each level.

In step S515 at least one vector is dropped-out of the latent code. For example, each level of the hierarchical levels of grids (except level 0) can include two or more vectors per grid. In the example described above, level 1 can be a 2³×64 grid of vectors, level 2 can be a 4³×32 grid of vectors, level 3 can be an 8³×16 grid of vectors, and level 4 can be a 16³×8 grid of vectors. The dropped-out inference can be generated by removing at last one vector from at least one level of the hierarchical levels of grids. The removed vectors can represent portions of the volume that have been removed in order to simulate an incomplete representation of the 3D object. In an example implementation, the vector associated with level 0 (e.g., the global level) is not selected for dropping out.

In step S520 a reconstructed volume is generated based on the dropped-out latent code. For example, the IR of the 3D object for each level (e.g., the global level (level (0) and the residual level(s) (level 2−n)) can be regenerated based on the grid (or grid of vectors) associated with each level. The IRs of the 3D object can be summed together to generate a composite IR of the 3D object that is used to generate the reconstructed volume.

In step S525 an encoder is trained, and a decoder is trained based on the reconstructed volume. For example, the encoder and the decoder operate together as a pair to compress and decompress the volume. Therefore, the encoder and the decoder can be trained together (e.g., as an autoencoder). The encoder and the decoder each include a neural network (e.g., a convolutional neural network) used to compress and decompress the volume (or latent code). Each node (e.g., convolution) in the neural network can have an associated weight. The associated weights can be randomly initialized and then revised in each training iteration (e.g., epoch). The training can be associated with implementing (or to help implementing) 3D object completion or shape completion. In an example implementation, the input volume and the reconstructed volume can be compared. A loss can be generated based on the difference between the input volume and the reconstructed volume. Training iterations can continue until the loss is minimized and/or until loss does not change significantly from iteration to iteration. In an example implementation, the lower the loss, the better the 3D object completion or shape completion and the better trained the encoder/decoder is.

For each iteration, example implementations can include using the same dropout vectors from iteration to iteration, changing the dropout vectors in each iteration, randomly selecting the dropout vectors, intelligently selecting the dropout vectors, using the same input volume for each iteration, changing the input volume for each iteration, and the like. Example implementation may include not selecting vectors from the global level (level 0) for dropout. In other words, dropout vectors may be selected only from the residual level(s) (level 2-n). Intelligently selecting the dropout vectors can include selecting a set of vectors associated with one portion of the 3D object, training the encoder/decoder pair using the selected set of vectors, then selecting a different set of vectors associated with a different portion of the 3D object, training the encoder/decoder pair using the selected different set of vectors, and repeating this cycle a plurality of times during the training operation.

FIG. 6 illustrates a diagram of a decoder-only inference mode according to at least one example embodiment. As shown in FIG. 6, in step S605 a latent code including random missing vectors is received. The latent code can be generated with at least one vector in a grid (or latent grid of vectors) from at least one level of hierarchical levels of grids included in the latent code. In an example implementation, the latent code is randomly generated and iteratively optimized to minimize the differences between the decoded shape and the input shape.

In step S610 a reconstructed volume is generated based on the latent code. For example, the latent code can be based on a volume compressed using an IR of the 3D object or randomly generated. The IR of the 3D object for each level (e.g., the global level (level (0) and the residual level(s) (level 2-n)) can be generated based on grid (or latent grid of vectors) including missing vectors associated with each level. The IRs of the 3D object can be summed together to generate a composite IR of the 3D object that is used to generate the reconstructed volume.

In step S615 a decoder is trained to modify latent code based on the reconstructed volume. For example, the decoder can operate independently of the encoder used to compress the volume. Therefore, the decoder can be trained independent of an encoder. The decoder can include a neural network (e.g., a convolutional neural network) used to decompress the latent code. Each node (e.g., convolution) in the neural network can have an associated weight. In this implementation, the associated weights can be fixed and not revised in each training iteration. The training can be associated with implementing (or to help implement) 3D object completion or shape completion. Accordingly, the latent code can be modified for 3D object completion or shape completion (without modifying neural network weights). Modifying latent code can include using Maximum-a-Posterior (MAP) estimation. In an example implementation, a ground truth volume and the reconstructed volume can be compared. A loss can be generated based on the difference between the ground truth volume and the reconstructed volume. In an example implementation, the learning can include generating a gradient based on the difference between the ground truth volume and the reconstructed volume (e.g., based on the loss). The decoder can learn to modify latent code using the gradient. Training iterations can continue until the loss is minimized and/or until loss does not change significantly from iteration to iteration. In an example implementation, the lower the loss, the better the 3D object completion or shape completion and the better trained the decoder is.

For each iteration, example implementations can include using the same dropout vectors from iteration to iteration, changing the dropout vectors in each iteration, randomly selecting the dropout vectors, intelligently selecting the dropout vectors, using the same input volume for each iteration, changing the input volume for each iteration, and the like. Example implementation may include not selecting vectors from the global level (level 0) for dropout. In other words, dropout vectors may be selected only from the residual level(s) (level 2-n). Intelligently selecting the dropout vectors can include selecting a set of vectors associated with one portion of the 3D object, training the encoder/decoder pair using the selected set of vectors, then selecting a different set of vectors associated with a different portion of the 3D object, training the encoder/decoder pair using the selected different set of vectors, and repeating this cycle a plurality of times during the training operation.

FIG. 7 illustrates a diagram of generating a reconstructed volume according to at least one example embodiment. As shown in FIG. 7, in step S705 latent code representing a volume is received. In an example implementation, a feature block can be generated based on an IR of the 3D object corresponding to the shape of a 3D object represented as a volume. The feature block can be used to generate a plurality of grids. The plurality of grids can be arranged in hierarchical levels. In level 0, there may be only one vector in the grid representing the global shape of the 3D object. In addition, at level 1 (and on to level n), there are a plurality of vectors in the grid associated with each level. Each vector can correspond to a portion of the 3D object.

In an example implementation, the volume representing the 3D object can be missing at least one portion of the object. Therefore, at least one of the plurality of grids can be missing at least one vector. 3D object completion or shape completion can be implemented in a trained encoder that generated the latent code representing the volume.

In step S710 the latent code is decoded. For example, a decoder can include a plurality of decoders including one decoder for each hierarchical level. The input to a decoder associated with hierarchical level 0 (or the global level) can be generated based on a concatenation of the grid (e.g., one vector) representing the global shape of the 3D object and a 3D position determined from the input IR of the 3D object. In the other hierarchical levels (n>0) the input to a decoder associated with hierarchical level n can be based on a concatenation of an upsampled version of the grid representing the global shape of the 3D object and the grid associated with the hierarchical level. These inputs can be decoded to generate an IR of the 3D object for each level. The IR of the 3D object for each level (e.g., the global level (level (0) and the residual level(s) (level 2-n)) can be generated based on the input to the decoder associated with each level. The IRs of the 3D object can be summed together to generate a composite IR of the 3D object that is used to generate the reconstructed volume.

3D object completion or shape completion can be implemented in the decoder as a trained decoder. The trained decoder can perform 3D object completion or shape completion together with the trained encoder or independent of the encoder based on the training being of the encoder/decoder pair or of the decoder alone as described above. 3D object completion or shape completion can include generating and inserting vectors where the grids are missing at least one vector.

In step S715 a reconstructed volume is generated based on the decoded latent code. For example, the IR of the 3D object generated as the summed global SDF and the residual IRs of the 3D object (e.g., the composite IR of the 3D object) can be converted from an IR of the 3D object to a volume (e.g., an image, a point cloud, a voxel, a mesh, and/or the like). The volume representing a 3D object can use the IR of the 3D object to assign a value using a binary classifier indicating whether the point is outside a shape or inside the shape.

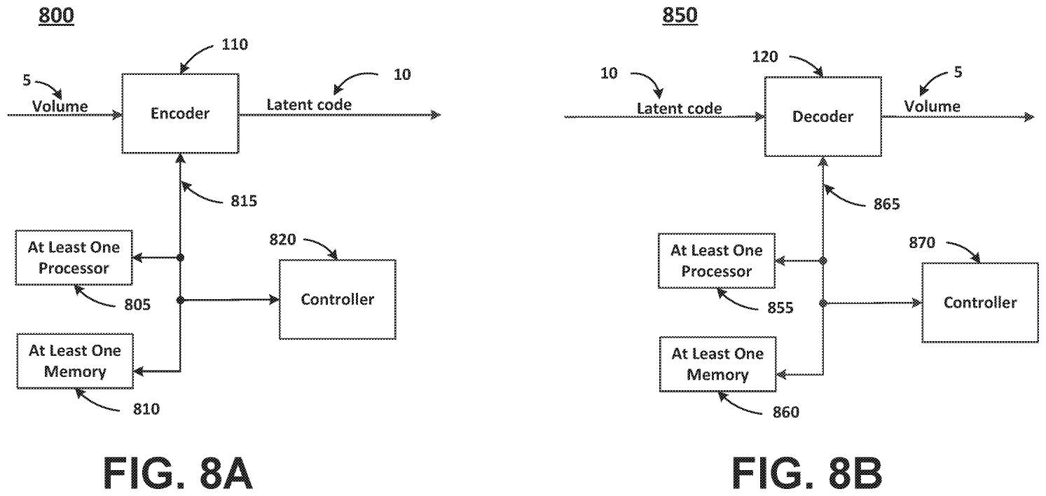

FIG. 8A illustrates an encoder system according to at least one example embodiment. As shown in FIG. 8A, the encoder system 800 includes the at least one processor 805, the at least one memory 810, a controller 820, and the encoder 110. The at least one processor 805, the at least one memory 810, the controller 820, and the encoder 110 are communicatively coupled via bus 815.

In the example of FIG. 8A, an encoder system 800 may be, or include, at least one computing device and should be understood to represent virtually any computing device configured to perform the techniques described herein. As such, the encoder system 800 may be understood to include various components which may be utilized to implement the techniques described herein, or different or future versions thereof. By way of example, the encoder system 800 is illustrated as including at least one processor 805, as well as at least one memory 810 (e.g., a non-transitory computer readable storage medium).

The at least one processor 805 may be utilized to execute instructions stored on the at least one memory 810. Therefore, the at least one processor 805 can implement the various features and functions described herein, or additional or alternative features and functions. The at least one processor 805 and the at least one memory 810 may be utilized for various other purposes. For example, the at least one memory 810 may represent an example of various types of memory and related hardware and software which may be used to implement any one of the modules described herein.

The at least one memory 810 may be configured to store data and/or information associated with the encoder system 800. The at least one memory 810 may be a shared resource. For example, the encoder system 800 may be an element of a larger system (e.g., a server, a personal computer, a mobile device, and/or the like). Therefore, the at least one memory 810 may be configured to store data and/or information associated with other elements (e.g., image/video serving, web browsing or wired/wireless communication) within the larger system.

The controller 820 may be configured to generate various control signals and communicate the control signals to various blocks in the encoder system 800. The controller 820 may be configured to generate the control signals to implement the techniques described herein. The controller 820 may be configured to control the encoder 110 to encode a volume, an image, a sequence of images, a video frame, a sequence of video frames, and/or the like according to example implementations. For example, the controller 820 may generate control signals corresponding to training a neural network associated with the encoder 110.

The encoder 110 may be configured to receive an input volume 5 (and/or a video stream) and output latent code 10. The encoder 110 may convert a video input into an IR of the 3D object. The input volume 5 may be compressed (e.g., encoded) as hierarchical levels of grids. The grids may include at least one vector. The hierarchical levels of grids and/or the at least one vector can be based on the IR of the 3D object. as hierarchical levels of grids. The grids may include at least one vector. The hierarchical levels of grids and/or the at least one vector can be generated (e.g., an inference or latent code) using a neural network. In other words, the encoder 110 can include a trainable and/or trained neural network. The encoder 110 can trained (or configured) to learn to complete 3D objects or shapes.

The latent code 10 may represent the output of the encoder system 800. For example, the latent code 10 may represent an encoded volume, image (or video frame). For example, the latent code 10 may be stored in a memory (e.g., at least one memory 810). For example, the latent code 10 may be ready for transmission to a receiving device (not shown). For example, the latent code 10 may be transmitted to a system transceiver (not shown) for transmission to the receiving device.

The at least one processor 805 may be configured to execute computer instructions associated with the controller 820 and/or the encoder 110. The at least one processor 805 may be a shared resource. For example, the encoder system 800 may be an element of a larger system (e.g., a mobile device, a server, and/or the like). Therefore, the at least one processor 805 may be configured to execute computer instructions associated with other elements (e.g., image/video serving, web browsing or wired/wireless communication) within the larger system.

FIG. 8B illustrates a block diagram of a decoder system according to at least one example embodiment. As shown in FIG. 8B, the decoder system 850 includes the at least one processor 855, the at least one memory 860, a controller 870, and the decoder 120. The at least one processor 855, the at least one memory 860, the controller 870, and the decoder 120 are communicatively coupled via bus 865.

In the example of FIG. 8B, a decoder system 850 may be at least one computing device and should be understood to represent virtually any computing device configured to perform the techniques described herein. As such, the decoder system 850 may be understood to include various components which may be utilized to implement the techniques described herein, or different or future versions thereof. For example, the decoder system 850 is illustrated as including at least one processor 855, as well as at least one memory 860 (e.g., a computer readable storage medium).

Therefore, the at least one processor 855 may be utilized to execute instructions stored on the at least one memory 860. As such, the at least one processor 855 can implement the various features and functions described herein, or additional or alternative features and functions. The at least one processor 855 and the at least one memory 860 may be utilized for various other purposes. For example, the at least one memory 860 may be understood to represent an example of various types of memory and related hardware and software which can be used to implement any one of the modules described herein. According to example implementations, the encoder system 800 and the decoder system 850 may be included in a same larger system (e.g., a personal computer, a mobile device, and the like).

The at least one memory 860 may be configured to store data and/or information associated with the decoder system 850. The at least one memory 860 may be a shared resource. For example, the decoder system 850 may be an element of a larger system (e.g., a personal computer, a mobile device, and the like). Therefore, the at least one memory 860 may be configured to store data and/or information associated with other elements (e.g., web browsing or wireless communication) within the larger system.

The controller 870 may be configured to generate various control signals and communicate the control signals to various blocks in the decoder system 850. The controller 870 may be configured to generate the control signals in order to implement the video encoding/decoding techniques described herein. The controller 870 may be configured to control the decoder 120 to decode a video frame according to example implementations.

The decoder 120 may be configured to receive compressed (e.g., encoded) latent code 10 as input and output a volume 5. The compressed (e.g., encoded) latent code 10 may also represent compressed video bits (e.g., a video frame). Therefore, the decoder 120 may convert discrete video frames of the latent code 10 into a video stream. The decoder 120 can be configured to (and/or be included in a system configured to) decompress (e.g., decode) a latent code (e.g., hierarchical layers of grids or grids of latent vectors). The decoder 120 can include a trainable and/or trained neural network. The decoder 120 can be trained (or configured) to learn to complete 3D objects or shapes.

The at least one processor 855 may be configured to execute computer instructions associated with the controller 870 and/or the decoder 120. The at least one processor 855 may be a shared resource. For example, the decoder system 850 may be an element of a larger system (e.g., a personal computer, a mobile device, and the like). Therefore, the at least one processor 855 may be configured to execute computer instructions associated with other elements (e.g., web browsing or wireless communication) within the larger system.

In a general aspect, a device, a system, a non-transitory computer-readable medium (having stored thereon computer executable program code which can be executed on a computer system), and/or a method can perform a process with a method including generating a first vector based on a first grid and a three-dimensional (3D) position associated with a first implicit representation (IR) of a 3D object, generating at least one second vector based on at least one second grid and an upsampled first grid, decoding the first vector to generate a second IR of the 3D object, decoding the at least one second vector to generate at least one third IR of the 3D object, generating a composite IR of the 3D object based on the second IR of the 3D object and the at least one third IR of the 3D object, and generating a reconstructed volume representing the 3D object based on the composite IR of the 3D object.

In another general aspect, a device, a system, a non-transitory computer-readable medium (having stored thereon computer executable program code which can be executed on a computer system), and/or a method can perform a process with a method including generating a first vector based on a first latent grid and a three-dimensional (3D) position associated with a signed distance function (SDF) representing a 3D object, generating at least one second vector based on at least one second latent grid and an upsampled first latent grid, decoding the first vector to generate a first SDF, decoding the at least one second vector to generate at least one second SDF, generating a composite SDF based on the first SDF and the at least one second SDF, and generating a reconstructed volume representing the 3D object based on the composite SDF.

In still another general aspect, a device, a system, a non-transitory computer-readable medium (having stored thereon computer executable program code which can be executed on a computer system), and/or a method can perform a process with a method including generating a feature set based on a representation of a three-dimensional (3D) object, generating a first grid of vectors based on the feature set, iteratively subdividing a volume associated with the feature set and generating at least one second grid of vectors based on a current iteration of the subdivided volume of the feature set, generating a latent code that includes a plurality of hierarchical layers including a first layer of the plurality of hierarchical layers includes the first grid and at least one second layer of the plurality of hierarchical layers includes the at least one second grid, generating a first vector based on the first grid of vectors and a 3D position associated with the 3D object, generating at least one second vector based on the at least one second grid of vectors and an upsampled first grid of vectors, decoding the first vector to generate a first partial representation of the 3D object, decoding the at least one second vector to generate at least one second partial representation of the 3D object, generating a composite representation of the 3D object based on the first partial representation of the 3D object and the at least one second partial representation of the 3D object, and generating a reconstructed volume representing the 3D object based on the composite representation of the 3D object.

Implementations can include one or more of the following features. For example, the first grid can include one vector representing a global shape of the 3D object. The at least one second grid can include two or more vectors each representing a portion of the 3D object. The at least one second grid can include a second grid and an nth grid, the at least one second grid can include two or more vectors each representing a portion of the 3D object, the second grid can include fewer vectors than the nth grid, and the second grid can include fewer details associated with the 3D object than the nth grid. The first IR of the 3D object can be missing a representation of a portion of the 3D object, and at least one of generating the second IR of the 3D object and generating the at least one third IR of the 3D object can include at least partially completing the missing representation of the portion of the 3D object.

Generating the at least one third IR of the 3D object can be performed by a decoder including a trained neural network, the neural network can be trained using latent code including dropped-out vectors associated with the at least one second grid, the dropped-out vectors simulating that the first IR of the 3D object is missing a representation of a portion of the 3D object, and the neural network is trained to complete the missing representation of the portion of the 3D object. The neural network can be trained using the reconstructed volume and a volume that the first IR of the 3D object is based on. Each of the at least one second vector can be generated based on a concatenation of a first sampled vector and a second sampled vector, the first sampled vector can be a trilinear interpolation of the upsampled first grid, and the second sampled vector can be a trilinear interpolation of a respective grid of the at least one second grid.

A latent code can include a plurality of hierarchical layers, a first layer of the plurality of hierarchical layers can include the first grid, and at least one second layer of the plurality of hierarchical layers can include the at least one second grid. The method can further include generating a feature set based on the first IR of the 3D object, generating the first grid based on the feature set, and iteratively subdividing a volume associated with the feature set and generating the at least one second grid based on a current iteration of the subdivided volume of the feature set. The number of iterations can define a resolution associated with the at least one third IR of the 3D object.

The method can further include a latent code that includes a plurality of hierarchical layers and a first layer of the plurality of hierarchical layers can include the first grid, and at least one second layer of the plurality of hierarchical layers can include the at least one second grid. The feature set can be generated using a neural network. The first IR of the 3D object can be missing a representation of a portion of the 3D object, the feature set is generated using a trained neural network, the neural network is trained to complete the missing representation of the portion of the 3D object while generating the feature set. The feature set can be generated using a trained neural network, the neural network can be trained using latent code including dropped-out vectors associated with the at least one second grid, the dropped-out vectors simulating that the first IR of the 3D object is missing a representation of a portion of the 3D object, and the neural network can be trained to complete the missing representation of the portion of the 3D object while generating the feature set.

The first grid can be generated using a trained neural network, the neural network can be trained using latent code including dropped-out vectors associated with the at least one second grid, the dropped-out vectors simulating that the first IR of the 3D object is missing a representation of a portion of the 3D object, and the neural network can be trained to complete the missing representation of the portion of the 3D object while generating the first latent grid. The at least one second grid can be generated using a trained neural network, the neural network can be trained using latent code including dropped-out vectors associated with the at least one second grid, the dropped-out vectors simulating that the IR of the 3D object is missing a representation of a portion of the 3D object, and the neural network can be trained to complete the missing representation of the portion of the 3D object while generating the at least one second grid.

The generating of the second IR of the 3D object can be performed by a decoder including a first trained neural network, the generating of the at least one third IR of the 3D object can be performed by the decoder including a second trained neural network, the first grid can be generated using a third trained neural network, the at least one second grid can be generated using at least one fourth trained neural network, the first neural network, the second neural network, the third neural network, and the at least one fourth trained neural network can be trained together using latent code including dropped-out vectors associated with the at least one second latent grid, the dropped-out vectors simulating that the IR of the 3D object is missing a representation of a portion of the 3D object, and the first neural network, the second neural network, the third neural network, and the at least one fourth trained neural network are trained together to complete the missing representation of the portion of the 3D object. The first vector can be a numeric value representing an attribute of the 3D object.

A grid can be a multi-dimensional array of numeric values each representing an attribute of the 3D object. The IR can include at least one observed variable that algorithmically infers at least one datum corresponding to a geometry of the 3D object. The method can further include generating the upsampled first grid by increasing at least one dimension associated with the first grid and extrapolating vector values for the increased at least one dimension based on vector values of the first grid. The composite IR can be a summing of the second IR of the 3D object with the at least one third IR of the 3D object. The generating of the reconstructed volume can include transforming the composite IR into renderable image data. The first IR can include a plurality of observed variables that algorithmically infers at least one datum corresponding to the 3D object, and the missing representation can be an absence of one or more of the plurality of observed variables.

The latent code can be a representation of compressed data corresponding to the 3D object, and the compressed data can include at least one a multi-dimensional array of vectors each representing an attribute of the 3D object. The latent code can include at least one multi-dimensional array of vectors each representing an attribute of the 3D object, and the dropped-out vectors can be vectors removed from the at least one multi-dimensional array of vectors. The latent code can include at least one multi-dimensional array of vectors each representing an attribute of the 3D object, and the hierarchical layers can be an organized structure of the at least one multi-dimensional array of vectors. The SDF can include at least one observed variable that algorithmically infers at least one datum corresponding to a geometry of the 3D object.

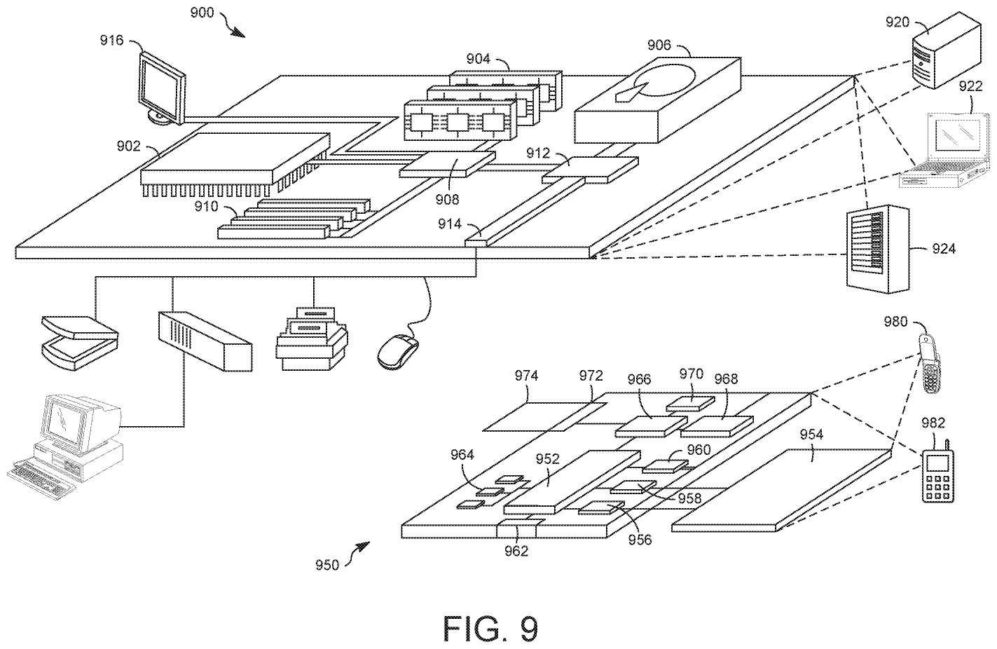

FIG. 9 shows an example of a computer device 900 and a mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low-speed interface 912 connecting to low-speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high-speed controller 908 manages bandwidth-intensive operations for the computing device 900, while the low-speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method comprising:
generating a first vector based on a first grid and a three-dimensional (3D) position associated with a first implicit representation (IR) of a 3D object;
generating at least one second vector based on at least one second grid and an upsampled first grid;
decoding the first vector to generate a second IR of the 3D object;
decoding the at least one second vector to generate at least one third IR of the 3D object;
generating a composite IR of the 3D object based on the second IR of the 3D object and the at least one third IR of the 3D object; and
generating a reconstructed volume representing the 3D object based on the composite IR of the 3D object.

2. The method of claim 1, wherein the first grid includes one vector representing a global shape of the 3D object.

3. The method of claim 1, wherein the at least one second grid includes two or more vectors each representing a portion of the 3D object.

4. The method of claim 1, wherein
the at least one second grid includes a second grid and an nth grid,
the at least one second grid includes two or more vectors each representing a portion of the 3D object,
the second grid includes fewer vectors than the nth grid, and
the second grid includes fewer details associated with the 3D object than the nth grid.

5. The method of claim 1, wherein
the first IR of the 3D object is missing a representation of a portion of the 3D object, and
at least one of generating the second IR of the 3D object and generating the at least one third IR of the 3D object includes at least partially completing the missing representation of the portion of the 3D object.

6. The method of claim 1, wherein
generating the at least one third IR of the 3D object is performed by a decoder including a trained neural network,
the neural network is trained using latent code including dropped-out vectors associated with the at least one second grid, the dropped-out vectors simulating that the first IR of the 3D object is missing a representation of a portion of the 3D object, and
the neural network is trained to complete the missing representation of the portion of the 3D object.

7. The method of claim 6, wherein the neural network is trained using the reconstructed volume and a volume that the first IR of the 3D object is based on.

8. The method of claim 1, wherein
each of the at least one second vector is generated based on a concatenation of a first sampled vector and a second sampled vector,
the first sampled vector is a trilinear interpolation of the upsampled first grid, and
the second sampled vector is a trilinear interpolation of a respective grid of the at least one second grid.

9. The method of claim 1, wherein
a latent code includes a plurality of hierarchical layers,
a first layer of the plurality of hierarchical layers includes the first grid, and
at least one second layer of the plurality of hierarchical layers includes the at least one second grid.

10. The method of claim 1, further comprising:
generating a feature set based on the first IR of the 3D object;
generating the first grid based on the feature set; and
iteratively subdividing a volume associated with the feature set and generating the at least one second grid based on a current iteration of the subdivided volume of the feature set.

11. The method of claim 10, wherein a number of iterations defines a resolution associated with the at least one third IR of the 3D object.

12. The method of claim 10, further comprising a latent code that includes a plurality of hierarchical layers, wherein
a first layer of the plurality of hierarchical layers includes the first grid, and
at least one second layer of the plurality of hierarchical layers includes the at least one second grid.

13. The method of claim 10, wherein the feature set is generated using a neural network.

14. The method of claim 10, wherein
the first IR of the 3D object is missing a representation of a portion of the 3D object,
the feature set is generated using a trained neural network,
the neural network is trained to complete the missing representation of the portion of the 3D object while generating the feature set.

15. The method of claim 10, wherein
the feature set is generated using a trained neural network,
the neural network is trained using latent code including dropped-out vectors associated with the at least one second grid, the dropped-out vectors simulating that the first IR of the 3D object is missing a representation of a portion of the 3D object, and
the neural network is trained to complete the missing representation of the portion of the 3D object while generating the feature set.

16. The method of claim 10, wherein
the first grid is generated using a trained neural network,
the neural network is trained using latent code including dropped-out vectors associated with the at least one second grid, the dropped-out vectors simulating that the first IR of the 3D object is missing a representation of a portion of the 3D object, and
the neural network is trained to complete the missing representation of the portion of the 3D object while generating the first latent grid.

17. The method of claim 10, wherein
the at least one second grid is generated using a trained neural network,
the neural network is trained using latent code including dropped-out vectors associated with the at least one second grid, the dropped-out vectors simulating that the IR of the 3D object is missing a representation of a portion of the 3D object, and
the neural network is trained to complete the missing representation of the portion of the 3D object while generating the at least one second grid.

18. The method of claim 10, wherein
generating the second IR of the 3D object is performed by a decoder including a first trained neural network,
generating the at least one third IR of the 3D object is performed by the decoder including a second trained neural network,
the first grid is generated using a third trained neural network
the at least one second grid is generated using at least one fourth trained neural network,
the first neural network, the second neural network, the third neural network, and the at least one fourth trained neural network are trained together using latent code including dropped-out vectors associated with the at least one second latent grid, the dropped-out vectors simulating that the IR of the 3D object is missing a representation of a portion of the 3D object, and
the first neural network, the second neural network, the third neural network, and the at least one fourth trained neural network are trained together to complete the missing representation of the portion of the 3D object.

19. A non-transitory computer-readable storage medium comprising instructions stored thereon that, when executed by at least one processor, are configured to cause a computing system to:
generate a first vector based on a first latent grid and a three-dimensional (3D) position associated with a signed distance function (SDF) representing a 3D object;
generate at least one second vector based on at least one second latent grid and an upsampled first latent grid;
decode the first vector to generate a first SDF;
decode the at least one second vector to generate at least one second SDF;
generate a composite SDF based on the first SDF and the at least one second SDF; and
generate a reconstructed volume representing the 3D object based on the composite SDF.

20. A non-transitory computer-readable storage medium comprising instructions stored thereon that, when executed by at least one processor, are configured to cause a computing system to:
generate a feature set based on a representation of a three-dimensional (3D) object;
generate a first grid of vectors based on the feature set;
iteratively subdividing a volume associated with the feature set and generating at least one second grid of vectors based on a current iteration of the subdivided volume of the feature set;
generate a latent code that includes a plurality of hierarchical layers including a first layer of the plurality of hierarchical layers includes the first grid and at least one second layer of the plurality of hierarchical layers includes the at least one second grid;
generate a first vector based on the first grid of vectors and a 3D position associated with the 3D object;
generate at least one second vector based on the at least one second grid of vectors and an upsampled first grid of vectors;
decode the first vector to generate a first partial representation of the 3D object;
decode the at least one second vector to generate at least one second partial representation of the 3D object;
generate a composite representation of the 3D object based on the first partial representation of the 3D object and the at least one second partial representation of the 3D object; and
generate a reconstructed volume representing the 3D object based on the composite representation of the 3D object.
